(19) United States
(12) Patent Application Publication
(10) Pub. No.: US 2015/0232762 A1
(43) Pub. Date: Aug. 20, 2015

(54) SEPARATING HYDROCARBONS AND INORGANIC MATERIAL

(71) Applicant: ENNOX OIL SOLUTIONS INC., Oslo (NO)

(72) Inventors: Mathias Wilichowski, Bak (DE); Knut Hansen, Sandefjord (NO)

(73) Assignee: ENNOX OIL SOLUTIONS INC., Skien (NO)

(21) Appl. No.: 14/429,696

(22) PCT Filed: Dec. 4, 2012
(86) PCT No.: PCT/NO2012/000067

§ 371 Date: Mar. 19, 2015

(30) Foreign Application Priority Data
May 16, 2012 (NO) 20120579

(51) Int. Cl. C10G 1/04; B01D 11/02; C10G 1/00

(52) U.S. Cl. CPC C10G 1/045; C10G 1/002; B01D 11/0265; B01D 11/0284

(57) ABSTRACT

A method for separating hydrocarbons from an initial mixture comprising agglomerates (200) of hydrocarbons and solid inorganic material (212) is disclosed. The method comprises the steps of grinding the agglomerates by exposing the initial mixture to a liquid dissolving agent and a medium (123, 123′) having kinetic energy, removing a film of hydrocarbons (211′) from the inorganic material (212) using cavitation and/or ultrasound, and separating liquid from the solid inorganic material (212). Compared to prior art, the method provides better separation and low consumption of heat, organic solvent and water. An apparatus and a system are also disclosed.

### BACKGROUND

1. Field of the Invention

The present invention concerns a method, apparatus and system separating hydrocarbons from an initial mixture comprising agglomerates of hydrocarbons and solid inorganic material.

2. Prior and Related Art

Sand contaminated with oil residue may represent an environmental problem. Sand containing oil, commonly referred to as ‘oil sand’ or ‘tar sand’, may also be a resource, and is exploited commercially in e.g. Canada and Alaska. In both instances, there is a need to separate hydrocarbons from sand, gravel and other inorganic material.

The mixture typically comprises viscous agglomerates with inorganic material and hydrocarbon components ranging from bitumen to light gases, which may be trapped in the more viscous components. In some cases the agglomerates may be relatively lightly attached to each other, and are thus easily separated from each other by light grinding and milling. In other cases, the mixture may be a viscous mass. For convenience, such a continuous mass is considered one, large agglomerate in the following description and claims.

Agglomerates have a relatively high viscosity, and may appear hard and rubberlike. Adding a solvent to such an agglomerate affects only the surface, i.e. a major part of the viscous material remains unaffected by the solvent.

In order to separate a viscous mass from inorganic material such as sand, work, i.e. energy, is required. Several prior art methods for separating hydrocarbons from an initial mixture of oil and sand supply the required energy as heat, e.g. as hot steam. In physical terms, the heat increases the temperature in the mixture, i.e. the molecular motion in the hydrocarbons, and thus decreases the viscosity of the mixture. By adding a suitable solvent and/or a surfactant to the heated, less viscous mixture, the hydrocarbons are more easily separated from the sand. One problem with these methods is high energy consumption, as the supplied heat to a large extent is wasted at the end of the process. Other problems include high water consumption, e.g. for generating steam, contamination of the water used in the process and relatively low extraction efficiencies. In addition, using hot water, steam, volatile hydrocarbons or volatile or non-volatile solvents involves health hazards and other risks.

The object of the present invention is to achieve a better separation of hydro carbons and inorganic material, preferably consuming less energy and water, than what can be achieved using prior art. Also, benefits from prior art should be retained where possible.

### SUMMARY OF THE INVENTION

The object is achieved by the method of claim 1, the apparatus of claim 11 and the system of claim 16.

In a first aspect, the invention concerns a method for separating hydrocarbons from an initial mixture comprising agglomerates of hydrocarbons and solid inorganic material The method comprises the steps of:
grinding the agglomerates by exposing the initial mixture to a liquid dissolving agent and a medium having kinetic energy,
removing a film of hydrocarbons from the inorganic material using cavitation and/or ultrasound, and
separating liquid from the solid inorganic material.

When sufficient kinetic energy is provided, the forces acting on the agglomerates cause cracks in the viscous material. This increases the surface exposed to the liquid dissolving agent and hence the dissolving rate.

After the initial step, a film of partly dissolved hydrocarbons still remains around the inorganic particles. This film is removed using cavitation and/or ultrasound. After the second step, the residues are suspended in a liquid phase, which can be separated from the inorganic material in the third step. Due to an effective removal of the film from the inorganic material, the method of the present invention achieves a better separation of hydrocarbons and inorganic material than prior art methods. Further, the method does not require supplied heat, which improves the economy compared to prior art processes wherein material is heated at the beginning and left to cool at the end of the process.

The liquid dissolving agent may comprise liquid hydrocarbons, in particular a light crude oil, which may be recovered in a later step. This leads to less consumption of solvent and improves the economy of the method.

The liquid dissolving agent preferably also comprises an aqueous solution of surfactant to keep hydrocarbons suspended in water until the liquid is separated from the solid inorganic material.

The kinetic energy for the initial grinding of agglomerates may be provided by grinding jets of liquid or milling bodies in a ball mill.

In a preferred embodiment, grinding the agglomerates and removing the film comprises exposing the mixture to jets of an aqueous solution of surfactant in one, elongated chamber. The jets provide an energy transfer which is particularly efficient for grinding agglomerates and removing a film of residues from the inorganic material.

Coarse inorganic material, such as gravel or rocks, in the initial mixture may be separated in, for example, a shale shaker and/or milled to a maximum grain size.

In a preferred embodiment, the separated liquid is further separated into liquid hydrocarbons and an aqueous solution of surfactant in a liquid-liquid separator. The aqueous solution may thus be reused, whereby less water is consumed.

In a second aspect, the invention concerns an apparatus for separating hydrocarbons from an initial mixture comprising agglomerates of hydrocarbons and solid inorganic material, the apparatus comprising a grinder comprising an inlet for the initial mixture, an inlet for a liquid dissolving agent and a medium provided with kinetic energy for grinding the agglomerates. According to the invention, the apparatus further comprises a film removing device adapted for removing a film of hydrocarbons from the inorganic material; and a liquid-solid separator capable of separating liquid from the solid inorganic material.

In a preferred embodiment, the grinder and the film removing device are provided within one elongate chamber, wherein the grinder is disposed at an inlet end of the chamber and the film removing device is disposed at an outlet end of the chamber.

In a further preferred embodiment, the inlet for the liquid dissolving agent is fed by a high-pressure pump providing an aqueous solution of surfactant and comprises a plurality of nozzles, whereby potential energy in a pressurized aqueous solution of surfactant is converted to kinetic energy in a plurality of jets.

Advantageously, such jets are directed for conveying the hydrocarbons and inorganic material from the inlet of the grinder to the liquid-solid separator.

In a further preferred embodiment, the elongated chamber is inclined downwards from the inlet, whereby gravity assists in conveying the material through the apparatus.

In a third aspect, the invention concerns a system for separating hydrocarbons from an initial mixture comprising agglomerates of hydrocarbons and solid inorganic material, the system comprising a surfactant tank with a feed line and a return line for an aqueous solution of surfactant; an apparatus as disclosed in the second aspect connected to the feed line; and a liquid-liquid separator adapted to separate liquid hydrocarbons from the aqueous solution and to feed the aqueous solution to the return line. The system saves water because the aqueous solution is reused. In addition, the system comprises an apparatus which provide a better separation than prior art with no heat consumption.

In a preferred embodiment, the system further comprises a solvent tank connected to the inlet for the initial mixture and/or the inlet for the liquid dissolving agent through one or more pump(s) and/or valve(s) for supplying a liquid solvent to the initial mixture. The liquid solvent is preferably a liquid hydrocarbon such as diesel oil, domestic heating oil or a light crude oil which can be separated from water and surfactant in the liquid-liquid separator.

In some embodiments the system further comprises a coarse grinder upstream from the inlet for agglomerates. The coarse grinder is adapted to decrease the particle size of the supplied solids, e.g. from rock or gravel to fine-grained sand with a predetermined maximum grain size.

In some embodiments, the system comprises a shale shaker. The shale shaker may replace or supplement the coarse grinder discussed above, and works by separating coarse material for separate treatment while fine-grained material is passed on to film removal.

In a preferred embodiment, the system further comprises a second film removing device on an output line for solids from the first liquid-solid separator. The second film-dissolving device can be a liquid powered cavitator and/or an ultrasonic device, and improves the separation of hydrocarbons from solid inorganic material still further, and with low losses of heat and water as discussed above.

### BRIEF DESCRIPTION OF THE DRAWINGS

The present invention will be described in the following detailed description with reference to the exemplary embodiments shown in the drawings, in which:

FIG. 1 illustrates breakdown of agglomerates and separation into a solid and a liquid phase.

FIG. 2 is a detailed illustration of the mechanism for grinding down agglomerates.

FIG. 3 is a detailed illustration of the mechanism for removing film from grains.

FIG. 4 shows a motion pattern of a ball mill; “cataract motion” at higher driving speeds, suited to produce coarse particle sizes.

FIG. 5 shows another motion pattern of a ball mill; “cascade motion” at lower driving speeds, suited to produce smaller particle sizes.

FIG. 6 schematically illustrates a system according to the present invention.

FIG. 7 schematically illustrates an alternative embodiment of the system according to the present invention.

FIG. 8 schematically illustrates a compact arrangement of the embodiment on FIG. 6 with an additional coarse grinder.

### DETAILED DESCRIPTION OF A PREFERRED EMBODIMENT

The drawings are schematic views intended to illustrate the principles of the present invention. They are not to scale, and numerous details known to the skilled person, such as motors, pumps, valves, etc. are omitted from the figures for clarity.

According to the invention, hydrocarbons and inorganic material is separated by first grinding the agglomerates by exposing the initial mixture to a liquid dissolving agent and a medium having kinetic energy, then removing a film of hydrocarbons from particles inorganic material and finally separate the inorganic material from a liquid phase wherein the hydrocarbons are suspended.

As used herein, “grinding” denotes the general process of breaking an agglomerate and/or inorganic material into smaller pieces. Correspondingly, a “grinder” is any device capable of grinding or milling material into smaller pieces. In the following description and claims, a distinction is made between a “grinder” intended for grinding agglomerates and a “coarse grinder” intended to grind rocks, gravel and other coarse, inorganic material. In practice, the “grinder” and “coarse ginder” may be provided as one device, such as a ball mill.

In the claims and the following description the liquid dissolving agent comprises a) an aqueous solution of surfactant and/or b) a solvent comprising liquid hydrocarbons. It is emphasized that the application at hand determines whether water or liquid hydrocarbons or both are part of the dissolving agent. If present, the surfactant is intended to keep hydrocarbons suspended in water until the liquid can be separated from the solid inorganic material.

The term “solvent” as used herein denotes a mixture of non-volatile liquid hydrocarbons, in particular diesel oil, domestic heating oil or a light crude oil. These liquid hydrocarbons can be recovered at a later step, thereby decreasing the consumption of solvent and improving the economy of the process.

If a mixture of solvent, water and surfactant is used as the liquid dissolving agent, the recovery of liquid hydrocarbons involves separating hydrocarbons from water in a liquid-liquid separator. In this case, the type and consentration of surfactant should preferably be selected so that the hydrocarbons are not emulsified in the water to a degree that makes it difficult or impossible to separate hydrocarbons from water in the liquid-liquid separator selected for the task. Advantageously, the amount of (emulsified) oil in water after liquid-liquid separation should be sufficiently low to permit reuse of the water, thereby limiting the water consumption in the process. The liquid-solid and liquid-liquid separations should be considered when designing a liquid dissolving agent for the application at hand. The details are left to one skilled in the art, and not further described herein.

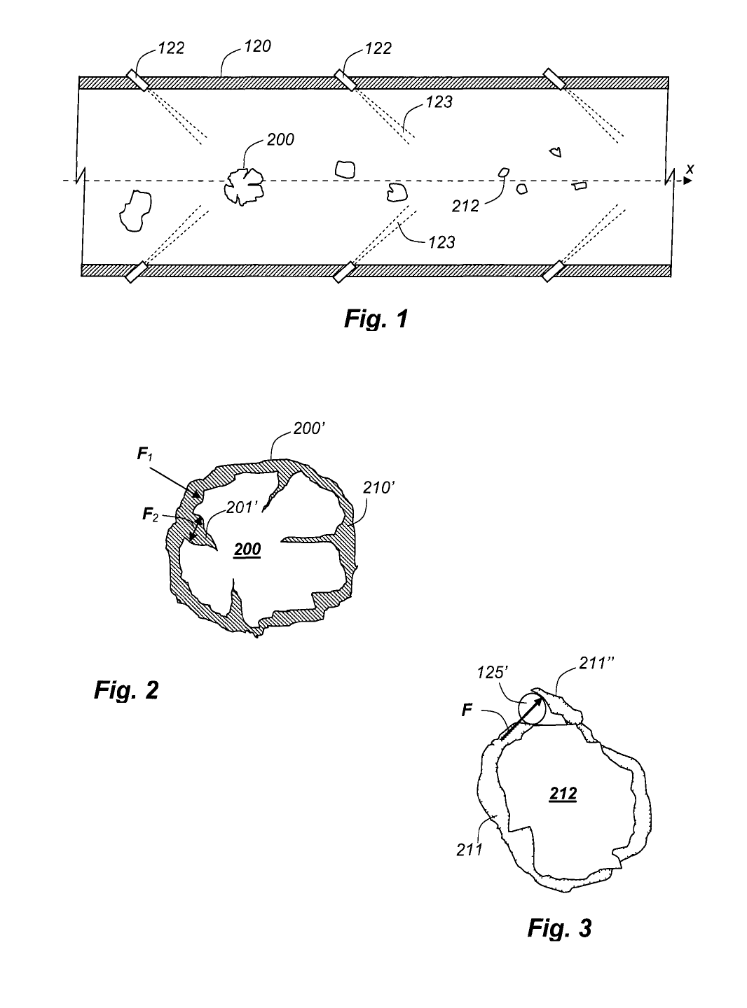

FIG. 1 schematically illustrates a preferred embodiment of a part of an apparatus according to the invention. In particular, FIG. 1 shows part of an elongate chamber 120 with an inlet for agglomerates near one end and an outlet at the other end. The inlet is to the left of FIG. 1 and the outlet is to the right of FIG. 1. A liquid-solid separator 150, which is also part of the apparatus according to the invention, is connected to the outlet from chamber 120.

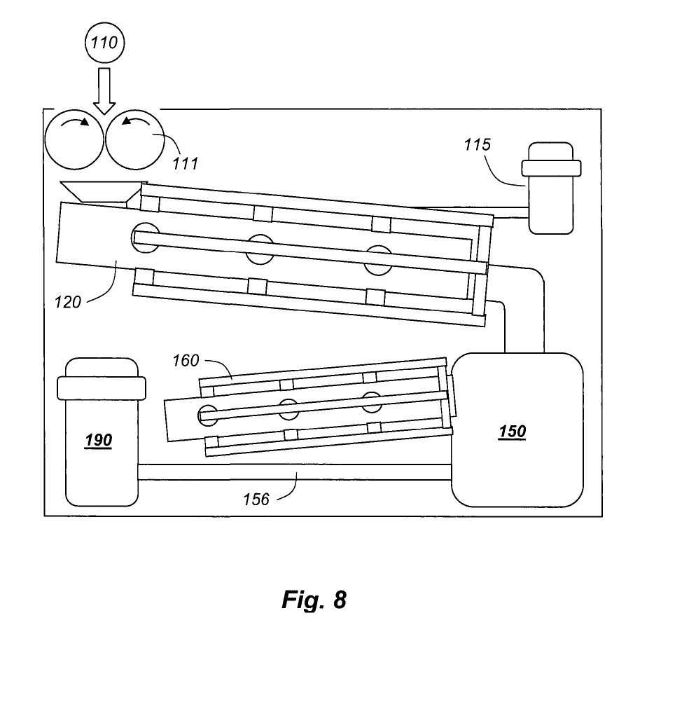

In the chamber 120, jets 123 of water are provided through a plurality of nozzles 122. The jets 123 is a first example of a medium provided with kinetic energy. As shown in FIG. 1, the jets 123 can be inclined with respect to the longitudinal axis x of the elongated body 120, and thereby help pushing the material in the x-direction from left to right on FIG. 1. As best seen on FIG. 8, the elongated chamber 120 can also be inclined from the inlet with respect to a horizontal plane, so that gravity helps pulling the material though the chamber 120.

FIG. 2 illustrates the first step of the method according to the invention, where agglomerates are broken into smaller pieces, and is a detailed view of an agglomerate 200 from the left part of FIG. 1. An initial outline 200′ depicting the outline of agglomerate at an earlier point in time is shown around the agglomerate 200. The hatching 210 illustrates material that has been removed from the original agglomerate, e.g. by a solvent comprising liquid hydrocarbons. Forces F₁, F₂ and F₃ illustrate how the jets 123 impinging on the agglomerate 200 may attack the surface and cause cracks in the agglomerate 200. Such cracks increases the area exposed to the liquid dissolving agent, and thereby the rate at which the agglomerate 200 is broken down. Providing sufficient kinetic energy in a medium is equivalent to providing sufficient forces to cause significant cracks in the agglomerates.

FIG. 3 illustrates the second step of the method, where a film 211 of partly dissolved hydrocarbons is removed from a particle 212 of inorganic material. The film 211 is removed near the outlet end of the chamber 120, i.e. to the right on FIG. 1. The film 211 comprises partly dissolved hydrocarbons and/or residues of solid hydrocarbons 211′. For simplicity the droplet is depicted as an expanding bubble 125 detaching a piece 211′ of the film 211 from the particle 212. However, it is understood that cavitation is an improtant mechanism in the film removal. A complete discussion of Bernoulli's equation is beyond the scope of the present invention, but a brief review of conservation of energy in the form of dynamic pressure p_{d} may clarify the concepts behind the invention:

$${p}_{d} = \frac{ρ \cdot {v}_{1}^{2}}{2} + {p}_{1} = \frac{ρ \cdot {v}_{2}^{2}}{2} + {p}_{2} \qquad ( 1 )$$

In the present application, the density ρ can be set equal to the density of water. An incoming droplet 125 has a static pressure p₁ and a velocity ν₁.

If a droplet hits the liquid surrounding the particle 212 and film 211, a sudden local increase of velocity ν₂ in the liquid leads to a sudden drop of local pressure p₂ according to equation (1). If the local pressure drops below the vapour pressure, a bubble forms and subsequently implodes. The implosion is quite violent and releases energy in a variety of forms, including acoustic shock waves. This is known as inertial cavitation, and provides sufficient power to overcome the adhesion forces between contaminants and substrates, i.e. hydrocarbons and inorganic material or a particle on the surface of an agglomerate.

If the droplet hits a particle 212 or agglomerate 200 having a mass much greater than the mass of the droplet, the sudden drop of ν₂ implies a corresponding sudden increase of static pressure p₂. This sudden increase of pressure may attack an area on the underside of a fragment of solid hydrocarbon 211′ as in FIG. 3 or an area inside a crack in an agglomerate as illustrated by force F₂ on FIG. 2.

For simplicity, the above mechanisms are referred to as “cavitation” and the associated device is termed a “liquid powered cavitator” in the present disclosure. Of course, the work performed on the film 211 or an agglomerate 200 cannot exceed the energy of the incoming droplet 125, so the above is just intended to illustrates that the input energy is delivered as relatively large, abrupt forces, which are sufficiently large to overcome the adhesion forces between, for example, heavy oil or bitumen 211′ and a grain of sand 212.

In some embodiments, the chamber 120 may be provided with internal spikes on its interior walls. The effect of such spikes is to cause abrupt, local increases of velocity in the liquid, thereby enhancing cavitation.

Further, hydrophobic materials, such as hydrocarbons are known to stabilize small bubbles, which starts to grow unbounded if the local pressure drops below the so-called Blake's treshold. The required pressure drop can be brought about by ultrasound. The subsequent collapse of the bubble causes cavitation with sufficient power to overcome the adhesion forces described above. Acoustic cavitation is a well known mechanism used in industrial cleaning applications, and an associated ultrasonic device can be employed as a supplement or an alternative to the liquid powered cavitator. The term “film removing device” as used herein is intended to comprise any device suitable for removing a thin film of hydrocarbons from inorganic material using the above mechanisms, including cavitation and/or ultrasound.

The hydrocarbons removed from the solid inorganic particles must be kept suspended in a liquid phase until the liquid phase can be separated from the solid, inorganic material in the liquid-solid separator 150. If the liquid phase contains water, emulsifying oil in water may cause problems in a later liquid-liquid separation. For this reason, the aqueous solution of surfactant may be designed to provide a limited period of time, e.g. approximately 20 seconds, before hydrocarbons reattach to the inorganic material and during which the liquid phase should be separated from the inorganic material. In other instances, the film may remain detached for a considerably longer period of time. Factors affecting the time in which the film is detached include the composition of the film, the choice and concentration of surfactant(s), temperature, pressure and other operational conditions within the device, e.g the amount of ongoing cavitation within chamber 120 or the cavitator 160 described below.

As noted in the discussion of equation (1), cavitation also works on the agglomerates 200. Returning briefly to FIG. 2, force F₁ illustrates that cavitation removes material from the surface of an agglomerate 200. Force F₂ illustrates that cracks may be widened, and thereby increase the surface exposed to cavitation effects. Hence, the hatched area 210 is not necessarily removed by solvent alone. Impinging droplets and/or cavitation may aid or replace solvent in attacking the surface of the agglomerates, i.e. in grinding the agglomerates. As noted, cavitation is an efficient way of delivering the input energy. Hence, the combined grinder and film removing device 120 shown on FIG. 1 is an energy efficient device.

Returning briefly to FIG. 1, the agglomerates are shown successively smaller toward the outlet end of the chamber 120. The term “grinder” as used in the claims refer to a region near the inlet end of the chamber 120, and the term “film removing device” refer to a region near the outlet end. However, there is no clear distinction between the “grinder” and “the film removing device” in the embodiment shown on FIG. 1.

The processes in chamber 120 do not require heat. In contrast, heat has been used in some prior art separators in order to decrease the viscosity of heavy oils and bitumen in the agglomerates. The heat provided is to a large extent conveyed with the material to sand pits and storage tanks. In a typical site where hydrocarbons are separated from sand and other inorganic material, there is no use for the excess heat, so the liquids and sand is simply left to cool, such that the cost of heating is lost. Even if the heat was recovered, e.g. for transport to a building, a significant amount of heat would be lost in heat exchangers and during transport. Thus, the invention is more energy efficient than the prior art methods using heat. The energy efficiency is further enhanced in that the input power is delivered through cavitation.

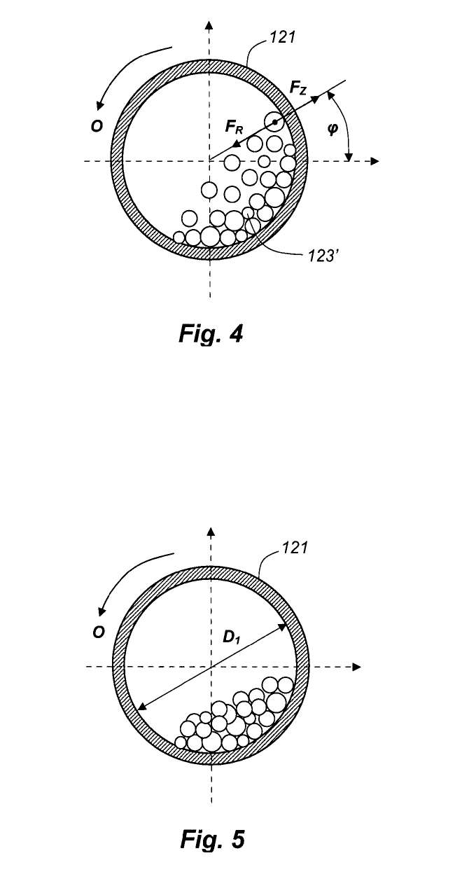

FIGS. 4 and 5 show a ball mill 121. A ball mill is a grinder comprising a drum containing steel balls or other milling bodies 123′. Ball mills are typically employed to mill brittle materials such as rock or ore. When the drum is rotated as indicated by the arrow O, the rotation may convey the balls a distance as indicated by the angle φ. The angle φ depends on the vertical lift, which in turn depends on the radial forces F_{R} and F_{z}, traction between a ball and the inner wall of the drum, the inner diameter D₁ of the drum, design of any carriers or dogs on the inner wall of the drum, etc. FIG. 4 illustrates a motion pattern known as “cataract motion”, which typically appears at higher driving speed and is suited to produce coarse particles, i.e. to obtain larger particle sizes. FIG. 5 illustrates a different motion pattern known as “cascade motion”, which typically appears at lower driving speed and is suited to produce finer particles, i.e. to obtain smaller particle sizes. The driving speed must not be higher than the critical driving speed, which is determined by the traction of the balls on the inner drum wall during rotation as discussed briefly above.

In the context of the present invention, the balls or milling bodies 123′ is a second example of a medium having kinetic energy, i.e. a medium that can be used for grinding the agglomerates as depicted on FIG. 2. In a ball mill, mechanical stresses are imposed by the balls or milling bodies set into motion by rotating the drum, and these stresses of forces are comparable to the kinetic energy provided by rotating the drum and setting the medium 123′ into motion.

In applications where the initial mixture contains coarse inorganic material such as rock or gravel, a ball mill might advantageously be employed to grind the coarse inorganic material as well as the agglomerates. This coarse grinding might produce particles with a predetermined maximum grain-size, so that the inorganic material does not damage centrifuges, cyclones or other equipment at later stages of the process. While the present disclosure makes a distinction between a grinder for grinding agglomerates and a coarse grinder for grinding rocks and other coarse material, it is understood that the two functions may be combined within one device such as a ball mill.

As noted with reference to FIG. 1 above, the liquid dissolving agent may comprise liquid hydrocarbons, termed “solvent” in the present disclosure. The solvent supports the grinding of agglomerates by dissolving the heavy oil and bitumen components at the new surfaces. This leads to a substantial increase of the mass transfer of hydrocarbons from the agglomerates into the solvent. Therefore the extraction time can be significantly reduced, e.g. from several hours in a fixed bed extractor to a few minutes in a ball mill.

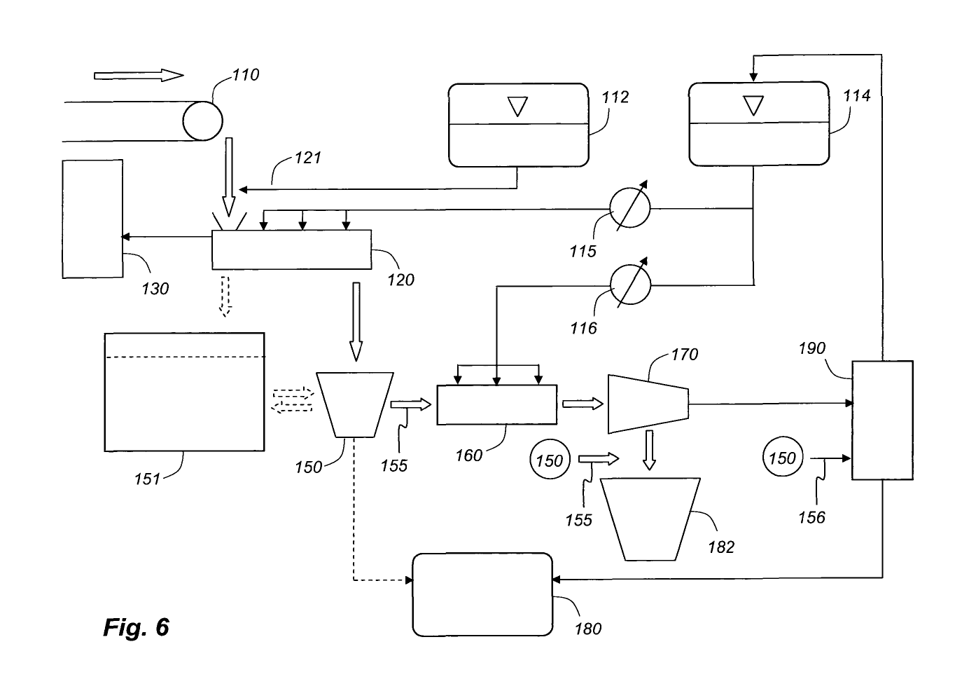

FIG. 6 shows schematically an exemplary preferred embodiment of a system according to the invention. Broad arrows indicate flow of material comprising a large fraction of solid inorganic matter and some liquid, whereas thin arrows illustrate flow of liquids and gases.

A conveyor 110 supplies initial mixture to the grinder at the inlet end of the chamber 120 shown in FIG. 1. An aqueous solution of surfactant is provided from a surfactant tank 114 to the chamber 120 though a plurality of nozzles. For clarity, pumps and valves are generally not shown in FIG. 6. However, high-pressure pumps 115, 116 are shown on the feed lines from surfactant tank 114 to the devices 120 and 160 respectively in order to illustrate that the pressure and kinetic energy discussed with reference to FIGS. 1-3 must be provided.

Disregarding the pressures and temperatures due to cavitation in small spots, the general operational conditions within the chamber 120 and other parts of the system are preferentially atmospheric pressure and ambient temperature. In some instances, however, heating some of the components of the system, e.g. the surfactant tank 114 and/or solvent tank 112, may be required to avoid freezing and disruption of the process. The energy required for such heating is small compared to the heating required for obtaining steam or for heating the initial mixture to decrease its viscosity.

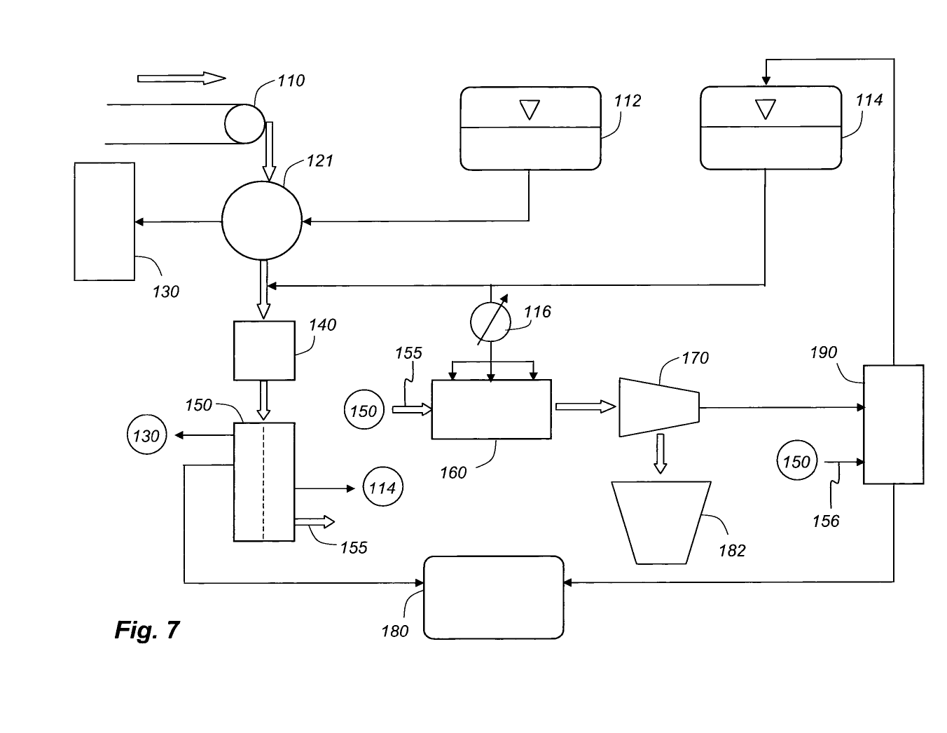

The particle size output from the chamber 120 can be, for example, in the range from 10 to 400 μm. However, the output particle sizes are not limited to this range. In some embodiments, a shale shaker 151 may be employed to separate coarse material, e.g gravel and rocks, which otherwise might harm equipment such as centrifuges or cyclones in the system. A shale shaker and coarse grinder may supplement each other as discussed with reference to FIG. 8 below. In the following description of the systems of FIGS. 6 and 7, the inorganic material is assumed to have a maximum grain size, i.e. that the agglomerates contain a mixture of sand and hydrocarbons.

Liquid hydrocarbons from the solvent tank 112 are also input to the grinder 120, which in the present example grinds the agglomerates in the presence of the solvent. As indicated above, the solvent, and hence the solvent tank 112, is optional.

Gases, for example volatile hydrocarbons initially trapped within the agglomerates and released during grinding and film separation or H₂S, can optionally be conveyed to a downstream gas treatment plant 130, which may be any suitable device, e.g. a commercially available plant. In FIG. 6, a feed line from device 120 is shown for illustration, and other gas lines are omitted for clarity. However, a gas treatment plant 130 may be required for environmental and safety reasons, and a feedline from any component in the system to the gas treatment plan 130 can be provided.

The main output from chamber 120 is fed to a liquid-solid separator 150 as indicated by a vertical arrow. This output contains particles of inorganic material and a liquid phase containing hydrocarbons suspended in water. The liquid-solid separator 150 should be designed to separate at least a major part of the solid particles from the liquid phase before the suspended hydrocarbons resettle on the inorganic material. A centifuge or hydrocyclone may be suitable for this task. In the liquid-solid separator 150, the liquid phase containing most of the hydrocarbons from the agglomerates is separated from the solid inorganic material. The liquid phase is fed to a liquid-liquid separator 190 as indicated by arrow 156.

Alternatively, the liquid solid separator 150 can be a gravity tank or other device capable of separating hydrocarbons, water and solids into separate fractions. In that case, hydrocarbons could be conveyed directly to an oil storage tank 180 as indicated by a dotted arrow on FIG. 6. The use of gravity tanks is further described with reference to FIG. 7.

Solid inorganic material from the liquid-solid separator 150 may be conveyed directly to a sand pit 182 or to an optional second film removing device or washing unit 160 as shown with broad arrows 155.

As the initial liquid phase is removed in the first liquid-spolid separator 150, the input to the second film removing device 160 is mainly wet sand with residues of hydrocarbons that were not removed by the first film removing device 120 and/or any hydrocarbons that have resettled on the inorganic material or sand grains before separation in the liquid-solid separator 150. In a preferred embodiment, the device 160 is a liquid powered cavitator similar to the one discussed with reference to FIG. 3. As above, an ultrasonic device may optionally supplement or replace the cavitator in the film removing device 160.

At the outlet of the second film removing device 160, hydrocarbon residues are once more suspended in a watery phase with surfactants. Due to the possibly limited time before hydrocarbons reattach to the sand, a centrifuge or cyclone is employed as the second liquid-solid separator 170 in the present example.

A secondary viscous phase containing substantially sand with a further reduced content of hydrocarbons is output from the second separator 170 and conveyed to the sand pit 182. A liquid phase containing substantially hydrocarbons suspended in water from the second separator 170 is conveyed to the liquid-liquid separator 190.

The liquid-liquid separator 190 is any commercially available type selected from operational requirements for throughput capacity, requirements for oil-in-water content, water-in-oil content at its output lines, etc. A return line to the surfactant tank 114 returns the aqueous solution of surfactant with a predetermined maximum level of hydrocarbons from the separator 190 to the surfactant tank 114. Another output line from the liquid-liquid separator 190 conveys hydrocarbons to the oil storage tank 180.

As noted, a proper composition of the aqueous surfactant solution should ensure that the extracted oil or the organic solvent will not be emulsified into the aqueous solution, i.e. the washing water. Hence, the aqueous solution can be recycled in the process and merely the amount lost in wet, clean sand in the sand pit 182 need to be replaced. Hence, the present process consumes far less water than some prior art processes.

FIG. 7 shows an alternative embodiment of a system according to the invention. Components with reference numerals similar to those on FIG. 6 have been explained with reference to FIG. 6 and will not be explained again with reference to FIG. 7.

In FIG. 7, the initial grinder is a ball mill 121 as described with reference to FIGS. 4 and 5. The solvent from tank 112 is no longer optional. The aqueous solution from surfactant tank 114 is provided to a mixer 140, and need not be pressurized by a pump 115. Hence, the high-pressure pump 115 appearing on FIG. 6 is not shown on FIG. 7. This does not mean that there is no pump conveying water and surfactant from the tank 114 to the mixer 140, as pumps and valves are generally not shown on FIGS. 6 and 7.

The first separator 150 on FIG. 7 is a gravity tank, i.e. a tank where the mixture is separated by density, with sand on the bottom and gases at the top. The separation between the different phases can be quite good if the mixture is allowed to settle for a period of time, as illustrated in FIG. 7 with an output 155 of sand from the bottom of the tank, an output of a watery phase for return to the surfactant tank 114, an output line for liquid hydrocarbons directly to the oil storage tank 180 and an output line for gases to the gas treatment plant 130 from the top of the tank 150. It is well known to arrange several such gravity tanks 150 in a round-robin system, so that the mixture is allowed to settle in one or more ‘currently inactive’ tanks while a ‘currently active’ gravity tank 150 is being filled from the mixer 140. This way, the mixture in each tank 150 is allowed to settle without sacrificing the overall throughput of the system. Such a round-robin system may be cost effective in applications where there is sufficient space for several gravity tanks 150.

In practice, one or more gravity tanks 150 can of course be combined with other separators in a known manner to achieve the operational requirements for throughput, footprint, maximum concentrations of oil in water, water in oil etc.

The mainly solid inorganic material with some water and residues of hydrocarbons is conveyed from the gravity tank(s) 150 to the washing unit 160 as illustrated by arrow 155 and treated further as discussed with reference to FIG. 6.

FIG. 8 illustrates an embodiment of the system of FIG. 6 arranged in a confined space, for example a container provided to protect the system from weather or climatic conditions on the extraction site. The small footprint of the system is largely due to the effective energy transfer within the grinder/cavitator 120 and the cavitator/washing unit 160.

In FIG. 8, the agglomerates are supplied from a conveyor 110 (FIG. 6), and milled in a coarse grinder 111. The coarse grinder 111 may be any device capable of grinding coarse inorganic material to a suitable particle size. A ball mill is previously mentioned as an example, and contra rotating drums as shown on FIG. 8 is provided as another example. In some instances, the time required to grind rocks to fine-grained sand may limit the throughput of the system. There may be other instances where the coarse grinder 111 is incapable of, or not designed for, grinding input material to small particles. In some cases a shale shaker may be employed to separate coarse inorganic material for separate treatment and configured to pass on fine-grained agglomerates and particles to subsequent parts of the system as illustrated on FIG. 6.

The coarse grinder 111 is optional, and coarse material may alternatively be sorted out before by means of a sieve, screen or shale shaker before the remaining material enters the system. The sorting may involve a light grinding that breaks the initial agglomerates, but not rocks or gravel, as known in the art.

FIG. 8 also shows the cavitation chamber 120 with an inclination downwards from its inlet to its outlet, whereby gravity helps pulling the material within the chamber towards the outlet and liquid-solid separator 115. The secondary film removing device 160 is inclined in a similar manner for the same reason.

The pump 115 provides pressure to the water and surfactant provided through nozzles in the cavitator 120. It is noted that the pump 115 need not always provide a large volumetric throughput, and that the pump 116 for providing pressure to the device 160 can be the same physical device as pump 115.

The line 156 conveying the liquid phase from the liquid-solid separator 150 to the liquid-liquid separator 190 is shown for a complete schematic impression of the main parts of the system.

While the above description is made by way of example and of certain embodiment, the invention is fully defined by the appended claims.

1. A method for separating hydrocarbons from an initial mixture comprising agglomerates of hydrocarbons and solid inorganic material, the method comprising:
grinding the agglomerates by exposing the initial mixture to a liquid dissolving agent and a medium having kinetic energy;
removing a film of hydrocarbons from the inorganic material using cavitation and/or ultrasound; and
separating liquid from the solid inorganic material.

2. The method according to claim 1, wherein grinding the agglomerates comprises exposing the initial mixture to a solvent comprising liquid hydrocarbons selected from a group consisting of: diesel oil, domestic heating oil, and a light crude oil.

3. The method according to claim 1, wherein grinding the agglomerates comprises exposing the agglomerates to an aqueous solution of surfactant.

4. The method according to claim 3, further comprising exposing the agglomerates to a plurality of jets of aqueous solution of surfactant, the jets providing the kinetic energy for grinding the agglomerates.

5. The method according to claim 1, wherein grinding the agglomerates comprises using a ball mill.

6. The method according to claim 1, wherein removing the film comprises exposing the initial mixture to a plurality of jets of an aqueous solution of surfactant.

7. The method according to claim 1, further comprising removing coarse inorganic material from the initial mixture.

8. The method according to claim 7, wherein removing coarse inorganic material comprises grinding the coarse inorganic material in a coarse grinder to particles with a predetermined maximum grain-size.

9. The method according to claim 7, wherein removing coarse inorganic material comprises separating the coarse inorganic material in a shale shaker.

10. The method according to claim 1, further comprising separating hydrocarbons from an aqueous solution of surfactant in a liquid-liquid separator.

11. An apparatus to separate hydrocarbons from an initial mixture comprising agglomerates of hydrocarbons and solid inorganic material, the apparatus comprising:
a grinder comprising:
an inlet for the initial mixture;
an inlet for a liquid dissolving agent; and
a medium provided with kinetic energy for grinding the agglomerates;
a film removing device configured to remove a film of hydrocarbons from the inorganic material; and
a liquid-solid separator configured to separate hydrocarbons suspended in the liquid dissolving agent from the solid inorganic material.

12. The apparatus according to claim 11, wherein the grinder and the film removing device are provided within one elongate chamber, and wherein the grinder is disposed at an inlet end of the chamber and the film removing device is disposed at an outlet end of the chamber.

13. The apparatus according to claim 11, wherein the inlet for the liquid dissolving agent is fed by a high-pressure pump providing an aqueous solution of surfactant and comprises a plurality of nozzles, whereby potential energy in a pressurized aqueous solution of surfactant is converted to kinetic energy in a plurality of jets.

14. The apparatus according to claim 13, wherein the jets are configured to convey the hydrocarbons and inorganic material from the inlet of the grinder toward the liquid-solid separator.

15. The apparatus according to claim 12, wherein the elongated chamber is inclined downwards from the inlet.

16. A system to separate hydrocarbons from an initial mixture comprising agglomerates of hydrocarbons and solid inorganic material, the system comprising:
a surfactant tank with a feed line and a return line for an aqueous solution of surfactant;
an apparatus according to claim 12 connected to the feed line; and
a liquid-liquid separator configured to separate hydrocarbons from the aqueous solution of surfactant and to feed the aqueous solution to the return line.

17. The system according to claim 16, further comprising a solvent tank connected to the inlet for the initial mixture and/or the inlet for the liquid dissolving agent through one or more pump and/or valve for supplying a liquid solvent to the initial mixture.

18. The system according to claim 17, wherein the solvent is selected from a group consisting of: diesel oil, domestic heating oil, and a light crude oil.

19. The system according to claim 16, further comprising a shale shaker.

20. The system according to claim 16 further comprising a coarse grinder upstream from the inlet for the initial mixture.

21. The system according to claim 16, further comprising a second film removing device on an output line for solids from the liquid-solid separator.
